(19) United States
(12) Patent Application Publication
(10) Pub. No.: US 2024/0357577 A1
(43) Pub. Date: Oct. 24, 2024

(54) INTRA-MULTIPLEXING BETWEEN EXTENDED REALITY AND ULTRARELIABLE LOW LATENCY COMMUNICATION TRAFFIC

(71) Applicant: Telefonaktiebolaget LM Ericsson (publ), Stockholm (SE)

(72) Inventor: Bikramjit SINGH, Raasepori (FI)

(21) Appl. No.: 18/569,293

(22) PCT Filed: Mar. 24, 2022
(86) PCT No.: PCT/SE2022/050280

§ 371 Date: Dec. 12, 2023

Related U.S. Application Data
(60) Provisional application No. 63/210,279, filed on Jun. 14, 2021.

(51) Int. Cl. H04W 72/12; H04W 72/0446; H04W 72/512; H04W 72/566

(52) U.S. Cl. CPC H04W 72/12; H04W 72/0446; H04W 72/512; H04W 72/566

(57) ABSTRACT

A network node configured to communicate with a wireless device (WD) is described. The network node includes processing circuitry configured to allocate at least a first resource for a physical uplink or downlink shared channel (PxSCH) for a first type of traffic and allocate at least a second resource for the PxSCH for a second type of traffic. The processing circuitry is further configured to refrain from at least one of transmitting and receiving any one of the first type of traffic and the second type of traffic when at least a first portion of the at least first resource overlaps at least a second portion of the at least second resource.

### TECHNICAL FIELD

The present disclosure relates to wireless communications, and in particular, to intra-multiplexing between extended reality (XR) and ultra-reliable low latency communication (URLLC) traffic.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), also referred to as user equipment (UE), as well as communication between network nodes and between WDs. Sixth Generation (6G) radio standards are also being developed.

Below is an excerpt from 3GPP Technical Standard (TS) 38.214 V16.5.0 (2021-03), which defines in-order transmission conditions for transmission in the downlink (DL) (e.g., physical downlink shared channel (PDSCH) and hybrid automatic repeat request acknowledgment (HARQ-ACK)):
“A UE shall upon detection of a PDCCH with a configured DCI format 1_0, 1_1 or 1_2 decode the corresponding PDSCHs as indicated by that DCI. For any HARQ process ID(s) in a given scheduled cell, the UE is not expected to receive a PDSCH that overlaps in time with another PDSCH. The UE is not expected to receive another PDSCH for a given HARQ process until after the end of the expected transmission of HARQ-ACK for that HARQ process, where the timing is given by Clause 9.2.3 of [6]. In a given scheduled cell, the UE is not expected to receive a first PDSCH and a second PDSCH, starting later than the first PDSCH, with its corresponding HARQ-ACK assigned to be transmitted on a resource ending before the start of a different resource for the HARQ-ACK assigned to be transmitted for the first PDSCH, where the two resources are in different slots for the associated HARQ-ACK transmissions, each slot is composed of N_{sym}^{slot} symbols or a number of symbols indicated by subslotLengthForPUCCH if provided, and the HARQ-ACK for the two PDSCHs are associated with the HARQ-ACK codebook of the same priority. In a given scheduled cell, the UE is not expected to receive a first PDSCH, and a second PDSCH, starting later than the first PDSCH, with its corresponding HARQ-ACK assigned to be transmitted on a resource ending before the start of a different resource for the HARQ-ACK assigned to be transmitted for the first PDSCH if the HARQ-ACK for the two PDSCHs are associated with HARQ-ACK codebooks of different priorities. For any two HARQ process IDs in a given scheduled cell, if the UE is scheduled to start receiving a first PDSCH starting in symbol j by a PDCCH ending in symbol i, the UE is not expected to be scheduled to receive a PDSCH starting earlier than the end of the first PDSCH with a PDCCH that ends later than symbol i. In a given scheduled cell, for any PDSCH corresponding to SI-RNTI, the UE is not expected to decode a re-transmission of an earlier PDSCH with a starting symbol less than N symbols after the last symbol of that PDSCH, where the value of N depends on the PDSCH subcarrier spacing configuration μ, with N=13 for μ=0, N=13 for μ=1, N=20 for μ=2, and N=24 for μ=3.”

As used herein, the term UE may refer to WD. DCI may refer to download control information. UCI may refer to upload control information.

### In-Order Transmissions Constraint for UL HARQ Process

Below is an excerpt from 3GPP TS 38.214 V16.5.0 (2021-03), which defines in-order transmission conditions for transmission in the uplink (UL) (e.g., physical uplink shared channel (PUSCH) and HARQ-ACK):
“A UE shall upon detection of a PDCCH with a configured DCI format 0_0, 0_1 or 0_2 transmit the corresponding PUSCH as indicated by that DCI unless the UE does not generate a transport block as described in [10, TS38.321]. Upon detection of a DCI format 0_1 or 0_2 with ‘UL-SCH indicator’ set to ‘0’ and with a non-zero ‘CSI request’ where the associated reportQuantity in CSI-ReportConfig set to ‘none’ for all CSI report(s) triggered by ‘CSI request’ in this DCI format 0_1 or 0_2, the UE ignores all fields in this DCI except the ‘CSI request’ and the UE shall not transmit the corresponding PUSCH as indicated by this DCI format 0_1 or 0_2. When the UE is scheduled with multiple PUSCHs by a DCI, HARQ process ID indicated by this DCI applies to the first PUSCH, as described in clause 6.1.2.1, HARQ process ID is then incremented by 1 for each subsequent PUSCH(s) in the scheduled order, with modulo 16 operation applied. For any HARQ process ID(s) in a given scheduled cell, the UE is not expected to transmit a PUSCH that overlaps in time with another PUSCH. For any two HARQ process IDs in a given scheduled cell, if the UE is scheduled to start a first PUSCH transmission starting in symbol j by a PDCCH ending in symbol i, the UE is not expected to be scheduled to transmit a PUSCH starting earlier than the end of the first PUSCH by a PDCCH that ends later than symbol i. The UE is not expected to be scheduled to transmit another PUSCH by DCI format 0_0, 0_1 or 0_2 scrambled by C-RNTI or MCS-C-RNTI for a given HARQ process until after the end of the expected transmission of the last PUSCH for that HARQ process.

If a UE is configured by higher layer parameter PDCCH-Config that contains two different values of coresetPoolIndex in ControlResourceSet for the active BWP of a serving cell and PDCCHs that schedule two non-overlapping in time domain PUSCHs are associated to different ControlResourceSets having different values of coresetPoolIndex, for any two HARQ process IDs in a given scheduled cell, if the UE is scheduled to start a first PUSCH transmission starting in symbol j by a PDCCH associated with a value of coresetPoolIndex ending in symbol i, the UE can be scheduled to transmit a PUSCH starting earlier than the end of the first PUSCH by a PDCCH associated with a different value of coresetPoolIndex that ends later than symbol i.

A UE is not expected to be scheduled by a PDCCH ending in symbol i to transmit a PUSCH on a given serving cell overlapping in time with a transmission occasion, where the UE is allowed to transmit a PUSCH with configured grant according to 3GPP TS38.321, starting in a symbol j on the same serving cell if the end of symbol i is not at least N₂ symbols before the beginning of symbol j. The value N₂ in symbols is determined according to the UE processing capability defined in Clause 6.4, and N₂ and the symbol duration are based on the minimum of the subcarrier spacing corresponding to the PUSCH with configured grant and the subcarrier spacing of the PDCCH scheduling the PUSCH.

If a UE receives an ACK for a given HARQ process in CG-DFI in a PDCCH ending in symbol i to terminate a transport block repetition in a PUSCH transmission with a configured grant on a given serving cell with the same HARQ process after symbol i, the UE is expected to terminate the repetition of the transport block in a PUSCH transmission starting from a symbol j if the gap between the end of PDCCH of symbol i and the start of the PUSCH transmission in symbol j is equal to or more than N2 symbols. The value N2 in symbols is determined according to the UE processing capability defined in Clause 6.4, and N2 and the symbol duration are based on the minimum of the subcarrier spacing corresponding to the PUSCH and the subcarrier spacing of the PDCCH indicating CG-DFI.

A UE is not expected to be scheduled by a PDCCH ending in symbol i to transmit a PUSCH on a given serving cell for a given HARQ process, if there is a transmission occasion where the UE is allowed to transmit a PUSCH with configured grant according to [10, TS38.321] with the same HARQ process on the same serving cell starting in a symbol j after symbol i, and if the gap between the end of PDCCH and the beginning of symbol j is less than N₂ symbols. The value N2 in symbols is determined according to the UE processing capability defined in Clause 6.4, and N₂ and the symbol duration are based on the minimum of the subcarrier spacing corresponding to the PUSCH with configured grant and the subcarrier spacing of the PDCCH scheduling the PUSCH.”

### Extended Reality (XR)

3GPP definition (SA4 TR26.928, 2019 February):
Extended reality (XR) refers to all real-and-virtual combined environments and human-machine interactions. A key aspect of XR is especially relating to the senses of existence (e.g., represented by VR) and the acquisition of cognition (e.g., represented by AR).
The boundary of VR and AR is now blurred.

The following is a table describing examples of high data rate and low latency service use cases.

TABLE 1
3GPP TS 22.261, Table 7.6.1-1 KPI Table for
high data rate and low latency service

| | Characteristic parameter (KPI) | | | | | |
|---|---|---|---|---|---|---|
| | Max | | | | | |
| | Allowed | Service bit | | Influence quantity | | |
| | End-to- | rate: user- | | | | Service |
| | end | experienced | | # of | | Area |
| Use Cases | latency | data rate | Reliability | UEs | UE Speed | (note 2) |
| Cloud/Edge/ | 5 ms (i.e. | 0.1-[1] Gbit/s | 99.99% in | — | Stationary | Country- |
| Split | UL + DL | supporting | uplink and | | or | wide |
| Rendering | between | visual content | 99.9% in | | Pedestrian | |
| (note 1) | UE and | (e.g. VR | downlink | | | |
| | the | based or high | (note 4) | | | |
| | interface | definition | | | | |
| | to data | video) with | | | | |
| | network) | 4K, 8K | | | | |
| | (note 4) | resolution and | | | | |
| | | up to120 fps | | | | |
| | | content. | | | | |
| Gaming or | 10 ms | 0.1-[1] Gbit/s | 99.99% | ≤ | Stationary | 20 m × |
| Interactive | (note 4) | supporting | (note 4) | [10] | or | 10 m; in |
| Data | | visual content | | | Pedestrian | one |
| Exchanging | | (e.g. VR | | | | vehicle |
| (note 3) | | based or high | | | | (up to 120 |
| | | definition | | | | km/h) and |
| | | video) with | | | | in one |
| | | 4K, 8K | | | | train (up |
| | | resolution and | | | | to 500 |
| | | up to120 fps | | | | km/h) |
| | | content. | | | | |
| Consume | [5-10] | 0.1-[10] | [99.99%] | — | Stationary | — |
| VR content | ms | Gbit/s | | | or | |
| via tethered | (note 5) | (note 5) | | | Pedestrian | |
| VR headset | | | | | | |
| (note 6) | | | | | | |

(note 1):
Unless otherwise specified, all communication via wireless link is between UEs and network node (UE to network node and/or network node to UE) rather than direct wireless links (UE to UE).
(note 2):
Length × width (×height).
(note 3):
Communication includes direct wireless links (UE to UE).
(note 4):
Latency and reliability KPIs can vary based on specific use case/architecture, e.g., for cloud/edge/split rendering, and may be represented by a range of values.
(note 5):
The decoding capability in the VR headset and the encoding/decoding complexity/time of the stream will set the required bit rate and latency over the direct wireless link between the tethered VR headset and its connected UE, bit rate from 100 Mbit/s to [10] Gbit/s and latency from 5 ms to 10 ms.
(note 6):
The performance requirement is valid for the direct wireless link between the tethered VR headset and its connected UE.

Requirements and traffic assumptions for XR SI in 3GPP:
Downlink video stream:
   Air interface PDB one way:
      AR/VR: 10 ms (baseline)
      Cloud gaming: 15 ms (baseline)
   Packet Arrival model:
      Average periodicity=1/{60, [120]}
         periodicity 16.67 ms [or 8.33 ms]
      Truncated Gaussian distribution:
         Mean: 0 ms; Std dev: 2 ms; Truncation: [−4; 4 ms]
   Average data rate for DL video stream:
      VR/AR: 30, 45 Mbps @60 fps (baseline)
         30, 60 Mbps @60 fps (optional)
      CG: 8, 30 Mbps @60 fps (baseline)
         8, 45 Mbps @60 fps (optional)
Uplink: FFS (WA: Pose/control, 4 ms, 100B)

Out-of-order (OOO) operation was considered in 3GPP Release 16 (Rel.16), but not enabled. That is, no OOO operation is allowed in Rel. 16 and, in 3GPP Release 17 (Rel. 17), OOO is not part of AI. A resultant problem is, when there is XR traffic (e.g., a prospective use case for evolved 5G and 6G)) operating in the nodes, the transmission size can span over multiple slots (e.g., in the order of 10s of slots) and physical resource blocks (PRBs). If URLLC traffic arrives after XR allocation grant downlink control information (DCI), then URLLC traffic related grant resource is allocated after a XR granted resource, thereby causing reliability/latency concerns for URLLC, as shown in FIG. 1. FIG. 1 shows an example allocation where, due to the size of XR allocations (PUSCH and/or PDSCH, herein referred to as PxSCH) and OOO restrictions, the URLLC must be transmitted after XR. Waiting to transmit one type of traffic (e.g., URLLC) until another type of traffic (e.g., XR) introduces latency (e.g., an undesired latency) for operations associated at least with the first type of traffic (e.g., URLCC).

This problem may also occur in a node with a mix of evolved mobile broadband (eMBB) and URLLC traffic, where eMBB traffic may be treated as slot-based traffic. Treating eMMB traffic as such may be performed such that in one slot there can be one eMBB independent transport block (TB) (e.g., where the largest size of an eMBB TB can be of one slot).

In sum, transmitting (and/or allocating and/or scheduling) traffic of one type (e.g., XR traffic, over multiple slots) and/or when traffic of another type (e.g., URLLC) is to be transmitted (and/or allocated and/or scheduled) may create latency problems (e.g., latency problems to URLLC latency sensitive traffic).

### SUMMARY

Some embodiments advantageously provide methods, systems, and apparatuses for intra-multiplexing between a first type of traffic (e.g., extended reality (XR) traffic) and a second type of traffic (e.g., ultra-reliable low latency communication (URLLC) traffic).

An intra-multiplex scenario is provided where URLLC traffic can be allocated with a grant/assignment which may overlap with previous XR allocated grant/assignment for the same node/WD. That is, the network (i.e., network node) may allow relaxation of OOO restriction(s) where URLLC and XR grants/assignment may collide/overlap. In a nonlimiting example, URLLC PxSCH is allocated, e.g., using intra-allocation, and is related to XR PxSCH(s). Further, OOO restrictions may not be followed. The network (i.e., network node) may be configured to define/determine how to avoid collisions and/or how to perform errorless transmission and/or reception when one or more (e.g., two) grants and/or assignments overlap and/or are multiplexed within the same WD.

Some embodiments provide intra-multiplexing techniques for multiplexing XR and URLLC traffic, relaxation of OOO restrictions for such multiplexing techniques, and mechanisms to resolve collisions due to multiplexing/overlapping.

An advantage of one or more embodiments may be that one type of traffic (e.g., URLLC traffic) may be transmitted without causing increased latency for an operation associated with the type of traffic (e.g., URLLC operation) such as latency arising from mixing one or more types of traffic (e.g., URLLC and XR traffic).

According to one aspect, a network node configured to communicate with a wireless device (WD) is described. The network node includes processing circuitry configured to: allocate at least a first resource for a physical uplink or downlink shared channel (PxSCH) for a first type of traffic; allocate at least a second resource for the PxSCH for a second type of traffic; and refrain from at least one of transmitting and receiving any one of the first type of traffic and the second type of traffic when at least a first portion of the at least first resource overlaps at least a second portion of the at least second resource.

In some embodiments, refraining includes refraining from at least one of transmitting and receiving the first type of traffic over an overlapping region of the at least first resource that collides with the at least second resource.

In some other embodiments, the at least first resource includes at least one time slot, each one of the at least one time slot includes at least one symbol, and refraining includes refraining from at least one of transmitting and receiving the first type of traffic over any one of: any time slot of the at least one time slot that overlaps at least partially with the at least second resource; and any symbol of the at least one symbol that overlaps at least partially with the at least second resource.

In one embodiment, the at least first resource includes at least one physical resource block (PRB), and refraining includes refraining from at least one of transmitting and receiving the first type of traffic over any PRB of the at least one PRB that overlaps at least partially with the at least second resource.

In another embodiment, the at least first resource includes at least one reference resource. Each reference resource of the at least one reference resource has a first reference resource length in a time domain and a second reference resource length in a frequency domain. Refraining includes refraining from at least one of transmitting and receiving the first type of traffic over any reference resource of the at least one reference resource that overlaps at least partially with the at least second resource.

In some embodiments, the at least first resource includes at least one transport block. Refraining includes refraining from at least one of transmitting and receiving the first type of traffic over any one of: any transport block of the at least one transport block that overlaps at least partially with the at least second resource; and a third portion of one transport block of the at least one transport block. The third portion overlaps at least partially with the at least second resource. A fourth portion of the transport block that does not overlap is used to transmit a resized transport block.

In some other embodiments, the resized transport block is indicated to the WD using control information.

In one embodiment, refraining includes refraining from at least one of transmitting and receiving the first type of traffic until a predetermined processing time associated with any one of the network node and the WD has been met.

In another embodiment, any one of the first type of traffic and the second type of traffic includes extended reality (XR) traffic, includes ultra-reliable low latency communication (URLLC) traffic, enhanced Mobile Broadband (eMBB) traffic, a traffic associated with a radio access technology.

In some embodiments, the first type of traffic and the second type of traffic are different.

In some other embodiments, the second type of traffic has higher priority than the first type of traffic.

In one embodiment, the at least one of the at least first resource and the at least second resource is allocated based at least in part on an out of order (OOO) restriction.

In another embodiment, the processing circuitry is further configured to cause the network node to transmit to the WD a resource allocation indication, the resource allocation indication indicating the at least first resource and the at least second resource. The at least first resource and the at least second resource are usable by the WD to at least one of receive and transmit the corresponding the first type of traffic and second type of traffic.

According to another aspect, A method in a network node configured to communicate with a wireless device (WD) is described. The method includes allocating at least a first resource for a physical uplink or downlink shared channel, (PxSCH) for a first type of traffic; allocating at least a second resource for the PxSCH for a second type of traffic; and refraining from at least one of transmitting and receiving any one of the first type of traffic and the second type of traffic when at least a first portion of the at least first resource overlaps at least a second portion of at least second resource.

In some embodiments, refraining includes refraining from at least one of transmitting and receiving the first type of traffic over an overlapping region of the at least first resource that collides with the at least second resource.

In some other embodiments, the at least first resource includes at least one time slot, each one of the at least one time slot includes at least one symbol, and refraining includes refraining from at least one of transmitting and receiving the first type of traffic over any one of: any time slot of the at least one time slot that overlaps at least partially with the at least second resource; and any symbol of the at least one symbol that overlaps at least partially with the at least second resource.

In one embodiment, the at least first resource includes at least one physical resource block (PRB), and refraining includes refraining from at least one of transmitting and receiving the first type of traffic over any PRB of the at least one PRB that overlaps at least partially with the at least second resource.

In another embodiment, the at least first resource includes at least one reference resource. Each reference resource of the at least one reference resource has a first reference resource length in a time domain and a second reference resource length in a frequency domain. Refraining includes refraining from at least one of transmitting and receiving the first type of traffic over any reference resource of the at least one reference resource that overlaps at least partially with the at least second resource.

In some embodiments, the at least first resource includes at least one transport block. Refraining includes refraining from at least one of transmitting and receiving the first type of traffic over any one of: any transport block of the at least one transport block that overlaps at least partially with the at least second resource; and a third portion of one transport block of the at least one transport block. The third portion overlaps at least partially with the at least second resource. A fourth portion of the transport block that does not overlap is used to transmit a resized transport block.

In some other embodiments, the resized transport block is indicated to the WD using control information.

In one embodiment, refraining includes refraining from at least one of transmitting and receiving the first type of traffic until a predetermined processing time associated with any one of the network node and the WD has been met.

In another embodiment, any one of the first type of traffic and the second type of traffic includes extended reality (XR) traffic, ultra-reliable low latency communication (URLLC) traffic, enhanced Mobile Broadband (eMBB) traffic, and a traffic associated with a radio access technology.

In some embodiments, the first type of traffic and the second type of traffic are different.

In some other embodiments, the second type of traffic has higher priority than the first type of traffic.

In one embodiment, the at least one of the at least first resource and the at least second resource is allocated based at least in part on an out of order (OOO) restriction.

In another embodiment, the method further includes transmitting to the WD a resource allocation indication, the resource allocation indication indicating the at least first resource and the at least second resource. The at least first resource and the at least second resource are usable by the WD to at least one of receive and transmit the corresponding the first type of traffic and second type of traffic.

According to one aspect, a wireless device (WD) configured to communicate with network node is described. The WD comprising processing circuitry configured to: cause the WD to receive a resource allocation indication, the resource allocation indication indicating at least a first resource for a physical uplink or downlink physical shared channel (PxSCH) for a first type of traffic and at least a second resource for the PxSCH for a second type of traffic; and refrain from at least one of transmitting and receiving any one of the first type of traffic and the second type of traffic when at least a first portion of the at least first resource overlaps at least a second portion of at least second resource.

In some embodiments, refraining includes refraining from at least one of transmitting and receiving the first type of traffic over an overlapping region of the at least first resource that collides with the at least second resource.

In some other embodiments, the at least first resource includes at least one time slot, each one of the at least one time slot includes at least one symbol, and refraining includes refraining from at least one of transmitting and receiving the first type of traffic over any one of: any time slot of the at least one time slot that overlaps at least partially with the at least second resource; and any symbol of the at least one symbol that overlaps at least partially with the at least second resource.

In one embodiment, the at least first resource includes at least one physical resource block (PRB), and refraining includes refraining from at least one of transmitting and receiving the first type of traffic over any PRB of the at least one PRB that overlaps at least partially with the at least second resource.

In another embodiment, the at least first resource includes at least one reference resource. Each reference resource of the at least one reference resource has a first reference resource length in a time domain and a second reference resource length in a frequency domain. Refraining includes refraining from at least one of transmitting and receiving the first type of traffic over any reference resource of the at least one reference resource that overlaps at least partially with the at least second resource.

In some embodiments, the at least first resource includes at least one transport block. Further, refraining includes refraining from at least one of transmitting and receiving the first type of traffic over any one of: any transport block of the at least one transport block that overlaps at least partially with the at least second resource; and a third portion of one transport block of the at least one transport block, the third portion overlapping at least partially with the at least second resource, a fourth portion of the transport block that does not overlap being used to transmit a resized transport block.

In some other embodiments, the resized transport block is indicated to the WD 22 using control information.

In one embodiment, refraining includes refraining from at least one of transmitting and receiving the first type of traffic until a predetermined processing time associated with any one of the network node and the WD has been met.

In some embodiments, any one of the first type of traffic and the second type of traffic includes at least one of extended reality (XR) traffic, ultra-reliable low latency communication (URLLC) traffic, enhanced Mobile Broadband (eMBB) traffic, and a traffic associated with a radio access technology.

In some other embodiments, the first type of traffic and the second type of traffic are different.

In one embodiment, the second type of traffic has higher priority than the first type of traffic.

In another embodiment, the at least one of the at least first resource and the at least second resource is allocated based at least in part on an out of order (OOO) restriction.

In some embodiments, the at least first resource and the at least second resource indicated by the received resource allocation indication are usable by the WD to at least one of receive and transmit the corresponding the first type of traffic and second type of traffic.

According to another aspect, a method in a wireless device (WD) configured to communicate with network node is described. The method comprises receiving a resource allocation indication, the resource allocation indication indicating at least a first resource for a physical uplink or downlink physical shared channel (PxSCH) for a first type of traffic and at least a second resource for the PxSCH for a second type of traffic; and refraining from at least one of transmitting and receiving any one of the first type of traffic and the second type of traffic when at least a first portion of the at least first resource overlaps at least a second portion of at least second resource.

In some embodiments, refraining includes refraining from at least one of transmitting and receiving the first type of traffic over an overlapping region of the at least first resource that collides with the at least second resource.

In some other embodiments, the at least first resource includes at least one time slot, each one of the at least one time slot includes at least one symbol, and refraining includes refraining from at least one of transmitting and receiving the first type of traffic over any one of: any time slot of the at least one time slot that overlaps at least partially with the at least second resource; and any symbol of the at least one symbol that overlaps at least partially with the at least second resource.

In one embodiment, the at least first resource includes at least one physical resource block (PRB), and refraining includes refraining from at least one of transmitting and receiving the first type of traffic over any PRB of the at least one PRB that overlaps at least partially with the at least second resource.

In another embodiment, the at least first resource includes at least one reference resource. Each reference resource of the at least one reference resource has a first reference resource length in a time domain and a second reference resource length in a frequency domain. Refraining includes refraining from at least one of transmitting and receiving the first type of traffic over any reference resource of the at least one reference resource that overlaps at least partially with the at least second resource.

In some embodiments, the at least first resource includes at least one transport block. Further, refraining includes refraining from at least one of transmitting and receiving the first type of traffic over any one of: any transport block of the at least one transport block that overlaps at least partially with the at least second resource; and a third portion of one transport block of the at least one transport block, the third portion overlapping at least partially with the at least second resource, a fourth portion of the transport block that does not overlap being used to transmit a resized transport block.

In some other embodiments, the resized transport block is indicated to the WD 22 using control information.

In one embodiment, refraining includes refraining from at least one of transmitting and receiving the first type of traffic until a predetermined processing time associated with any one of the network node and the WD has been met.

In some embodiments, any one of the first type of traffic and the second type of traffic includes at least one of extended reality (XR) traffic, ultra-reliable low latency communication (URLLC) traffic, enhanced Mobile Broadband (eMBB) traffic, and a traffic associated with a radio access technology.

In some other embodiments, the first type of traffic and the second type of traffic are different.

In one embodiment, the second type of traffic has higher priority than the first type of traffic.

In another embodiment, the at least one of the at least first resource and the at least second resource is allocated based at least in part on an out of order (OOO) restriction.

In some embodiments, the at least first resource and the at least second resource indicated by the received resource allocation indication are usable by the WD to at least one of receive and transmit the corresponding the first type of traffic and second type of traffic.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates latency in URLLC due to allocations for XR;

FIG. 2 is a schematic diagram of an example network architecture illustrating a communication system connected via an intermediate network to a host computer according to the principles in the present disclosure;

FIG. 3 is a block diagram of an example host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node for intra-multiplexing between extended reality (XR) and ultra-reliable low latency communication (URLLC) traffic according to some embodiments of the present disclosure;

FIG. 9 is a flowchart of an example process in a wireless device for intra-multiplexing between extended reality (XR) and ultra-reliable low latency communication (URLLC) traffic according to some embodiments of the present disclosure;

FIG. 10 is a flowchart of another example process in a network node according to some embodiments of the present disclosure;

FIG. 11 is a flowchart of another example process in a wireless device according to some embodiments of the present disclosure;

FIG. 12 illustrates an example allocation according to some embodiments of the present disclosure;

FIG. 13 shows an example of URLLC and XR traffic overlap according to some embodiments of the present disclosure;

FIG. 14 shows another example of URLLC and XR traffic overlap according to some embodiments of the present disclosure;

FIG. 15 shows an example collision of URLLC and XR traffic according to some embodiments of the present disclosure;

FIG. 16 shows another example collision of URLLC and XR traffic according to some embodiments of the present disclosure;

FIG. 17 shows an example of fully dropping a transport block according to some embodiments of the present disclosure;

FIG. 18 shows an example of resizing a transport block in case of URLLC and XR traffic overlap according to some embodiments of the present disclosure;

FIG. 19 shows an example transmission of configuration information (CI) alongside transport blocks according to some embodiments of the present disclosure; and

FIG. 20 shows another example of a partial transmission where a timeline for the WD to cancel XR allocations is partially met according to some embodiments of the present disclosure.

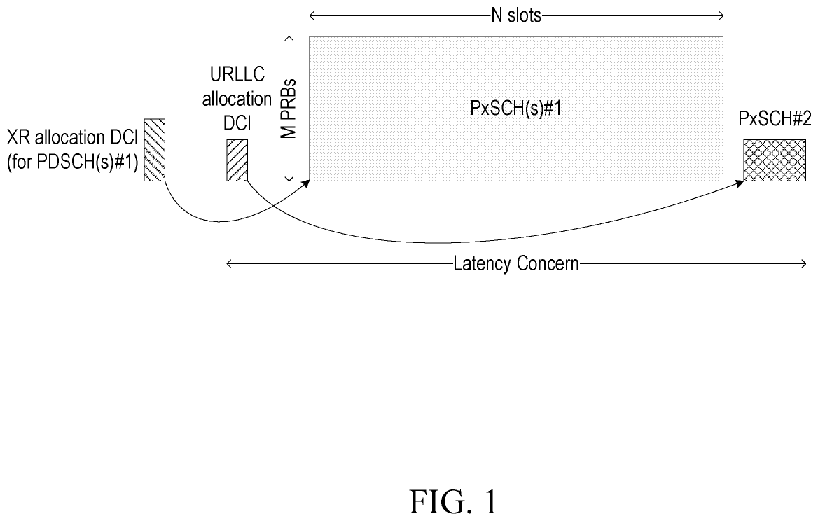

### DETAILED DESCRIPTION

Before describing in detail example embodiments, it is noted that the embodiments reside primarily in combinations of apparatus components and processing steps related to intra-multiplexing between a first type of traffic (e.g., extended reality (XR) traffic) and a second type of traffic (e.g., ultra-reliable low latency communication (URLLC) traffic). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

The term PxSCH may refer to PUSCH and/or PDSCH. However, PxSCH is not limited as such and may be any other channel. The term resource may refer to any resource used by one device to communicate with another device. A resource may include a time-domain structure and/or a frequency-domain structure. In a nonlimiting example, a resource may include, but without being limited to, one or more of each one of a frame, subframe, a time slot (also referred to as a slot), a mini-slot, a symbol such as an orthogonal frequency division multiplexed (OFDM) symbol, a resource block, a resource element, a physical resource block, a transport block, a communication channel such as PUSCH, PDSCH, PUCCH, PDCCH, PxSCH, etc. A resource may have a time component (e.g., associated with a time domain) and/or a frequency component (e.g., associated with a frequency-domain).

The term overlap may refer to at least a portion (e.g., in a time domain and/or a frequency domain) of a resource extending (and/or being scheduled and/or allocated and/or transmitted and/or received and/or assigned and/or determined) over a portion (e.g., in a time domain and/or a frequency domain) of another resource and/or having at least a portion of each resource in common.

The term traffic may refer to any data (which may include video data and/or audio data) and/or information and/or signaling. Traffic may also refer to any data and/or information and/or signal that is transmitted and/or received and/or scheduled and/or allocated and/or determined to be transmitted and/or received. In one non limiting example, traffic may refer to any transmission and/or reception occurring between a WD and a network node, between two or more WDs, between two or more network nodes, within a WD, within a network node, etc. Traffic may also be associated with or have traffic type. A traffic type may include extended reality (XR) traffic, ultra-reliable low latency communication (URLLC) traffic, eMBB traffic, traffic associated with a radio access technology such as LTE traffic, NR traffic. However, traffic and traffic type are not limited as such and may be any kind of traffic and traffic type, respectively.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide intra-multiplexing between extended reality (XR) and ultra-reliable low latency communication (URLLC) traffic. As described herein, XR traffic may refer to a first type of traffic, and URLLC traffic may refer to a second type of traffic.

One or more of the following assumptions may be implicit or explicit in some embodiments:
1. Assignment terminology may be used for DL resource allocation for data transmissions, e.g., PDSCH(s), which can be part of:
   a. Dynamic assignment; and/or
   b. Semi-persistent scheduling (SPS);
2. Grant allocation terminology may be used for UL resource allocation for data transmission, e.g., PUSCH(s), which can be part of:
   a. Dynamic grant; and/or
   b. Configured grant (CG);
3. Below embodiments may be applied for an operation in/with:
   a. Licensed spectrum, e.g., NR;
   b. Unlicensed spectrum, e.g., NR-U;
   c. Frequency division duplex (FDD) pattern;
   d. Time division duplex (TDD) pattern; and
   e. Combinations of above;
4. URLLC may have higher priority than XR traffic and/or resource allocations. These priorities may be indicated via physical layer (PHY) priority allocation indicated in respective allocation DCIs. For URLLC and/or XR, the same embodiments can be applied where two types of traffics (i.e., a first type of traffic and a second type of traffic) are interacting with different PHY or medium access control (MAC) priorities; and
5. Slots may be one form of time unit for some of the embodiments disclosed below. However, slot can be replaced by sub-slot, mini-slot, and/or any other slot definition, e.g., where one slot is composed of T orthogonal frequency division multiplexed (OFDM) symbols.

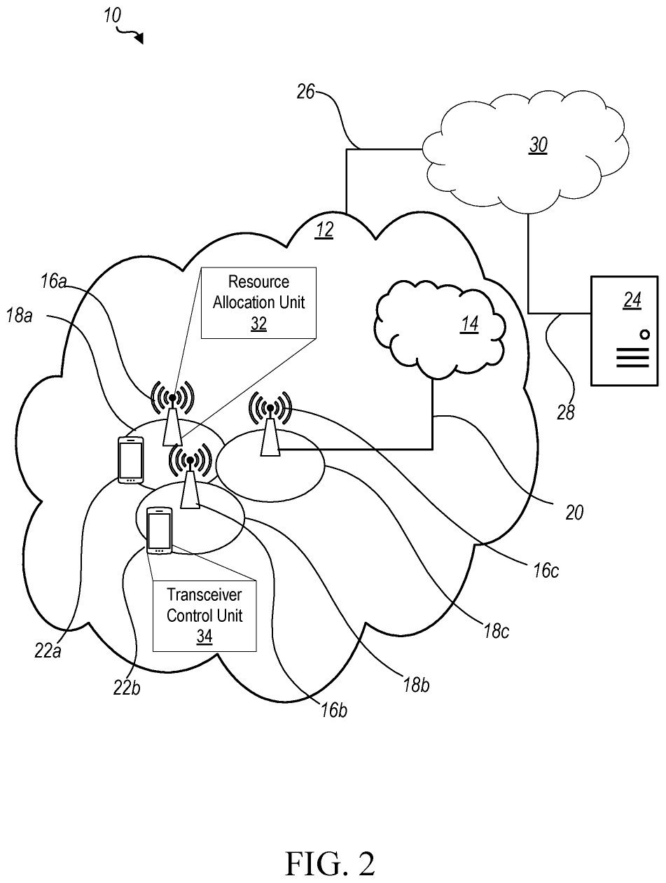

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a resource allocation unit 32 which is configured to perform any method and/or task and/or step and/or function and/or process and/or feature of the present disclosure, e.g., allocate resources for a physical uplink or downlink shared channel (PxSCH) for one or more types of traffic (e.g., XR traffic, URLLC traffic) and/or refrain (and/or cause the WD 22 and/or any of its components to refrain) from at least one of transmitting and receiving any one of the first type of traffic and the second type of traffic when at least a first portion of the at least first resource overlaps at least a second portion of the at least second resource.

A wireless device 22 is configured to include a transceiver control unit 34 which is configured to perform any method and/or task and/or step and/or function and/or process and/or feature of the present disclosure, e.g., cause the WD 22 (and/or any of its components) to receive a resource allocation indication, the resource allocation indication indicating at least a first resource for a physical uplink or downlink physical shared channel, PxSCH, for a first type of traffic and at least a second resource for the PxSCH for a second type of traffic; and/or refrain from at least one of transmitting and receiving any one of the first type of traffic and the second type of traffic when at least a first portion of the at least first resource overlaps at least a second portion of at least second resource.

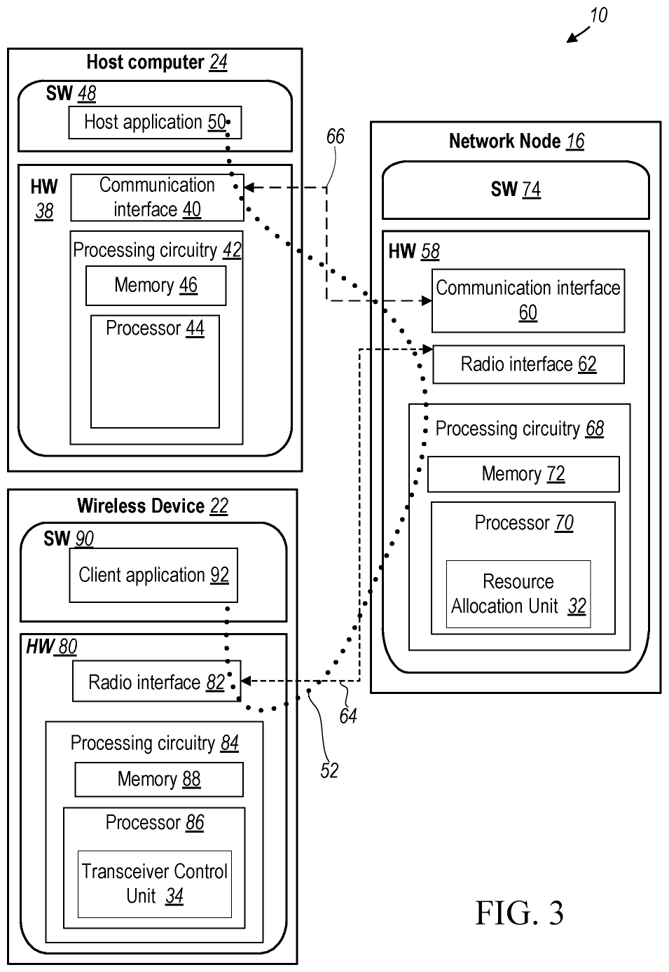

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include the resource allocation unit 32 which is configured to perform any method and/or task and/or step and/or function and/or process and/or feature of the present disclosure, e.g., allocate resources for a physical uplink or downlink shared channel (PxSCH) for one or more types of traffic (e.g., XR traffic, URLLC traffic) and/or refrain from at least one of transmitting and receiving any one of the first type of traffic and the second type of traffic when at least a first portion of the at least first resource overlaps at least a second portion of the at least second resource.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include the transceiver control unit 34 which is configured to perform any method and/or task and/or step and/or function and/or process and/or feature of the present disclosure, e.g., cause the WD 22 (and/or any of its components) to receive a resource allocation indication, the resource allocation indication indicating at least a first resource for a physical uplink or downlink physical shared channel, PxSCH, for a first type of traffic and at least a second resource for the PxSCH for a second type of traffic; and/or refrain from at least one of transmitting and receiving any one of the first type of traffic and the second type of traffic when at least a first portion of the at least first resource overlaps at least a second portion of at least second resource.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as resource allocation unit 32, and transceiver control unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

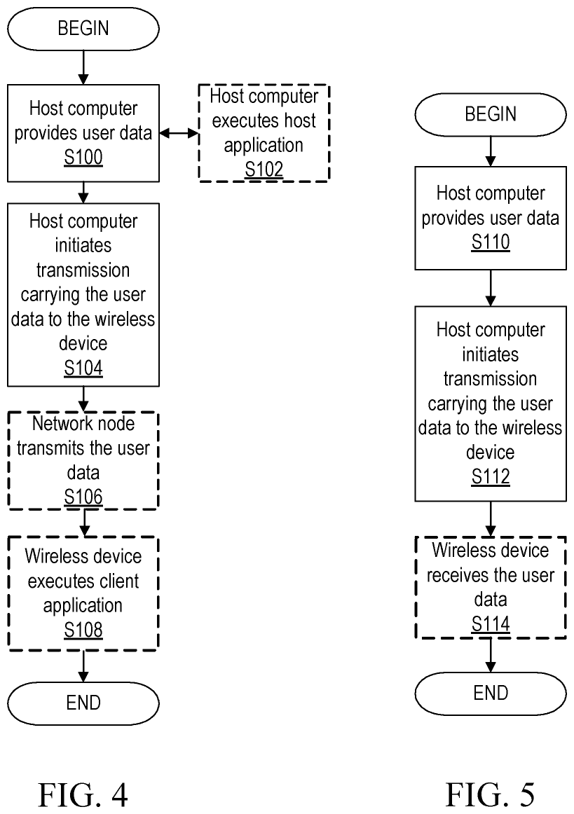

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

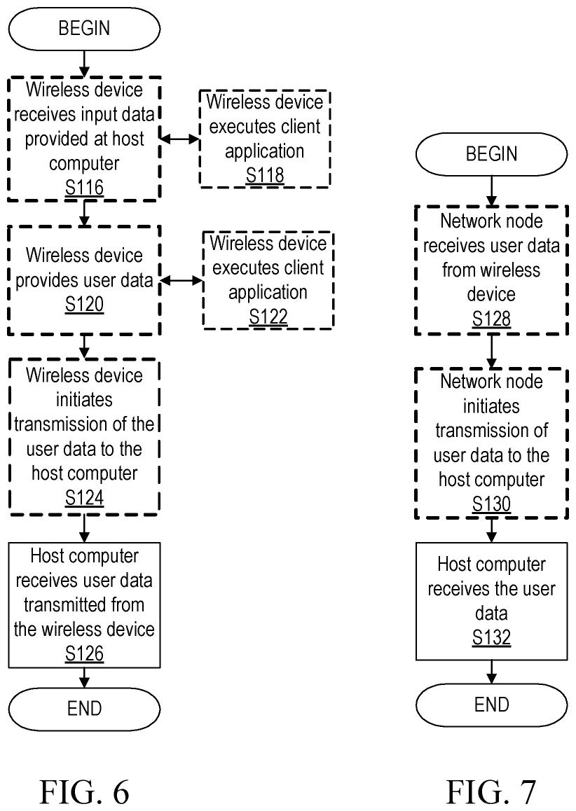

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

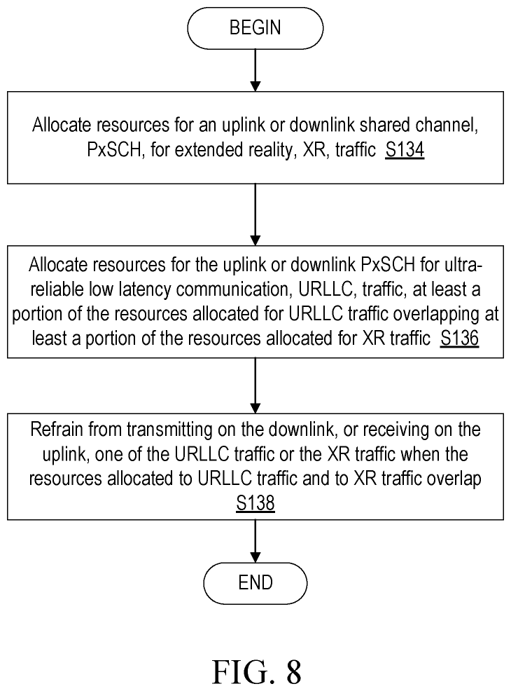

FIG. 8 is a flowchart of an example process in a network node 16 for intra-multiplexing between extended reality (XR) and ultra-reliable low latency communication (URLLC) traffic. One or more blocks described herein may be performed by one or more elements of network node 16 such as by one or more of processing circuitry 68 (including the resource allocation unit 32), processor 70, radio interface 62 and/or communication interface 60. Network node 16 such as via processing circuitry 68 and/or processor 70 and/or radio interface 62 and/or communication interface 60 is configured to allocate resources for an uplink or downlink shared channel, PxSCH, for extended reality, XR, traffic (Block S134). The process also includes allocating resources for the uplink or downlink PxSCH for ultra-reliable low latency communication, URLLC, traffic, at least a portion of the resources allocated for URLLC traffic overlapping at least a portion of the resources allocated for XR traffic (Block S136). The process further includes refraining from transmitting on the downlink, or receiving on the uplink, one of the URLLC traffic or the XR traffic when the resources allocated to URLLC traffic and to XR traffic overlap (Block S138).

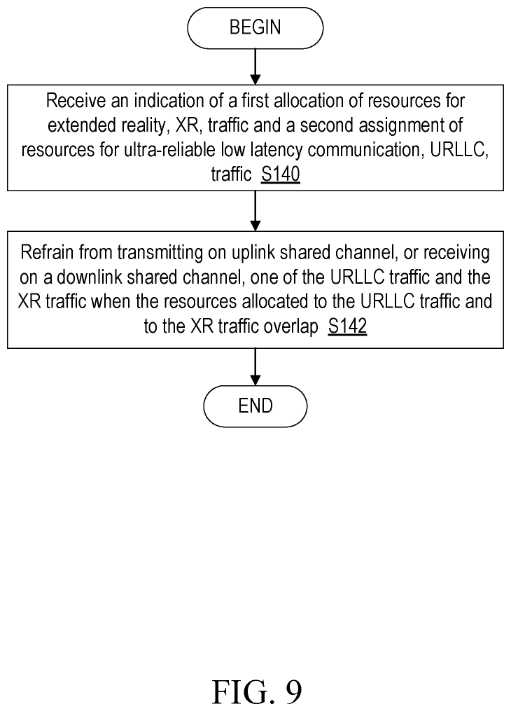

FIG. 9 is a flowchart of an example process in a wireless device 22 according to some embodiments of the present disclosure. One or more blocks described herein may be performed by one or more elements of wireless device 22 such as by one or more of processing circuitry 84 (including the transceiver control unit 34), processor 86, radio interface 82 and/or communication interface 60. Wireless device 22 such as via processing circuitry 84 and/or processor 86 and/or radio interface 82 is configured to receive an indication of a first allocation of resources for extended reality, XR, traffic and a second assignment of resources for ultra-reliable low latency communication, URLLC, traffic (Block S140). The process also includes refraining from transmitting the one of the URLLC traffic and the XR traffic not having the higher priority when the resources allocated to the URLLC traffic and to the XR traffic overlap (Block S142).

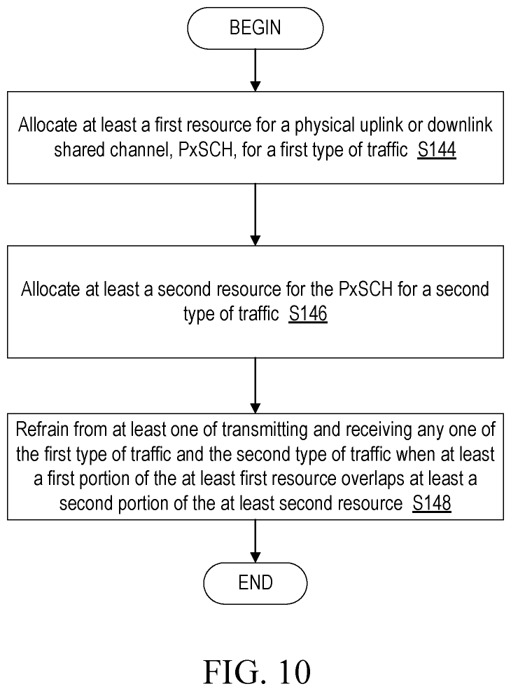

FIG. 10 is a flowchart of another example process in a network node 16 according to some embodiments. One or more blocks described herein may be performed by one or more elements of network node 16 such as by one or more of processing circuitry 68 (including the resource allocation unit 32), processor 70, radio interface 62 and/or communication interface 60. Network node 16 such as via processing circuitry 68 and/or processor 70 and/or radio interface 62 and/or communication interface 60 is configured to allocate (Block S144) at least a first resource 100a for a physical uplink or downlink shared channel, PxSCH, for a first type of traffic; allocate (Block S146) at least a second resource 100b for the PxSCH for a second type of traffic; and refrain (Block S148) from at least one of transmitting and receiving any one of the first type of traffic and the second type of traffic when at least a first portion of the at least first resource 100a overlaps at least a second portion of the at least second resource 100b.

In some embodiments, refraining includes refraining from at least one of transmitting and receiving the first type of traffic over an overlapping region of the at least first resource 100a that collides with the at least second resource 100b.

In some other embodiments, the at least first resource 100a includes at least one time slot 104, each one of the at least one time slot 104 includes at least one symbol, and refraining includes refraining from at least one of transmitting and receiving the first type of traffic over any one of: any time slot of the at least one time slot 104 that overlaps at least partially with the at least second resource 100b; and any symbol of the at least one symbol that overlaps at least partially with the at least second resource 100b.

In one embodiment, the at least first resource 100a includes at least one physical resource block, PRB 106, and refraining includes refraining from at least one of transmitting and receiving the first type of traffic over any PRB of the at least one PRB 106 that overlaps at least partially with the at least second resource 100b.

In another embodiment, the at least first resource 100a includes at least one reference resource 108. Each reference resource of the at least one reference resource 108 has a first reference resource length in a time domain and a second reference resource length in a frequency domain. Refraining includes refraining from at least one of transmitting and receiving the first type of traffic over any reference resource of the at least one reference resource 108 that overlaps at least partially with the at least second resource 100b.

In some embodiments, the at least first resource 100a includes at least one transport block 110. Refraining includes refraining from at least one of transmitting and receiving the first type of traffic over any one of: any transport block of the at least one transport block 110 that overlaps at least partially with the at least second resource 100b; and a third portion of one transport block of the at least one transport block 110. The third portion overlaps at least partially with the at least second resource 100b. A fourth portion of the transport block 110 that does not overlap is used to transmit a resized transport block.

In some other embodiments, the resized transport block is indicated to the WD 22 using control information 102c.

In one embodiment, refraining includes refraining from at least one of transmitting and receiving the first type of traffic until a predetermined processing time associated with any one of the network node 16 and the WD 22 has been met.

In another embodiment, any one of the first type of traffic and the second type of traffic includes at least one of extended reality, XR, traffic, ultra-reliable low latency communication, URLLC, traffic, enhanced Mobile Broadband, eMBB, traffic, and a traffic associated with a radio access technology.

In some embodiments, the first type of traffic and the second type of traffic are different.

In some other embodiments, the second type of traffic has higher priority than the first type of traffic.

In one embodiment, the at least one of the at least first resource 100a and the at least second resource 100b is allocated based at least in part on an out of order, OOO, restriction.

In another embodiment, the method further includes: transmitting to the WD 22 a resource allocation indication, the resource allocation indication indicating the at least first resource 100a and the at least second resource 100b. The at least first resource 100a and the at least second resource 100b are usable by the WD 22 to at least one of receive and transmit the corresponding the first type of traffic and second type of traffic.

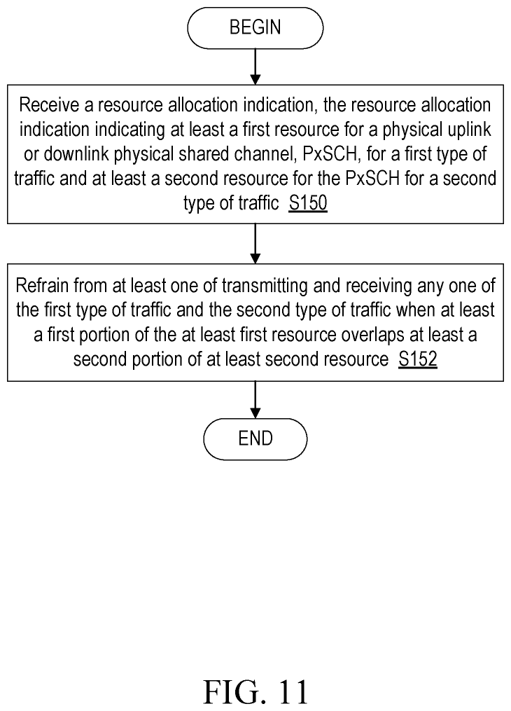

FIG. 11 is a flowchart of an example process in a wireless device 22 according to some embodiments. One or more blocks described herein may be performed by one or more elements of wireless device 22 such as by one or more of processing circuitry 84 (including the transceiver control unit 34), processor 86, radio interface 82 and/or communication interface 60. Wireless device 22 such as via processing circuitry 84 and/or processor 86 and/or radio interface 82 is configured to receive (Block S150) a resource allocation indication, the resource allocation indication indicating at least a first resource 100a for a physical uplink or downlink physical shared channel (PxSCH) for a first type of traffic and at least a second resource 100b for the PxSCH for a second type of traffic; and refrain (Block S152) from at least one of transmitting and receiving any one of the first type of traffic and the second type of traffic when at least a first portion of the at least first resource overlaps at least a second portion of at least second resource.

In some embodiments, refraining includes refraining from at least one of transmitting and receiving the first type of traffic over an overlapping region of the at least first resource 100a that collides with the at least second resource 100b.

In some other embodiments, the at least first resource 100a includes at least one time slot 104, each one of the at least one time slot 104 includes at least one symbol 112, and refraining includes refraining from at least one of transmitting and receiving the first type of traffic over any one of: any time slot of the at least one time slot 104 that overlaps at least partially with the at least second resource 100b; and any symbol of the at least one symbol that overlaps at least partially with the at least second resource 100b.

In one embodiment, the at least first resource 100a includes at least one physical resource block (PRB) 106, and refraining includes refraining from at least one of transmitting and receiving the first type of traffic over any PRB of the at least one PRB 106 that overlaps at least partially with the at least second resource 100b.

In another embodiment, the at least first resource 100a includes at least one reference resource 108. Each reference resource of the at least one reference resource 108 has a first reference resource length in a time domain and a second reference resource length in a frequency domain. Refraining includes refraining from at least one of transmitting and receiving the first type of traffic over any reference resource of the at least one reference resource 108 that overlaps at least partially with the at least second resource 100b.

In some embodiments, the at least first resource 100a includes at least one transport block 110. Further, refraining includes refraining from at least one of transmitting and receiving the first type of traffic over any one of: any transport block of the at least one transport block 110 that overlaps at least partially with the at least second resource 100b; and a third portion of one transport block of the at least one transport block 110, the third portion overlapping at least partially with the at least second resource 100b, a fourth portion of the transport block 110 that does not overlap being used to transmit a resized transport block.

In some other embodiments, the resized transport block is indicated to the WD 22 using control information 102c.

In one embodiment, refraining includes refraining from at least one of transmitting and receiving the first type of traffic until a predetermined processing time associated with any one of the network node 16 and the WD 22 has been met.

In some embodiments, any one of the first type of traffic and the second type of traffic includes at least one of extended reality (XR) traffic, ultra-reliable low latency communication (URLLC) traffic, enhanced Mobile Broadband (eMBB) traffic, and a traffic associated with a radio access technology.

In some other embodiments, the first type of traffic and the second type of traffic are different.

In one embodiment, the second type of traffic has higher priority than the first type of traffic.

In another embodiment, the at least one of the at least first resource 100a and the at least second resource 100b is allocated based at least in part on an out of order (OOO) restriction.

In some embodiments, the at least first resource 100a and the at least second resource 100b indicated by the received resource allocation indication are usable by the WD 22 to at least one of receive and transmit the corresponding the first type of traffic and second type of traffic.

Having described the general process flow of arrangements of the disclosure and having provided examples of hardware and software arrangements for implementing the processes and functions of the disclosure, the sections below provide details and examples of arrangements for intra-multiplexing between extended reality (XR) and ultra-reliable low latency communication (URLLC) traffic.

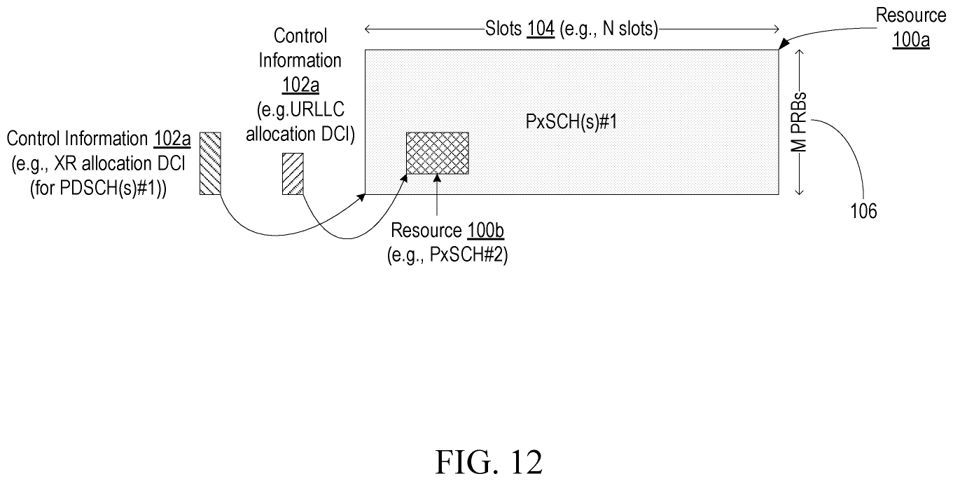

FIG. 12, shows an example URLLC PxSCH that is allocated, e.g., using intra-allocation, and related to XR PxSCH(s). In this nonlimiting example, OOO restrictions may not be followed. The network (i.e., network node 16) may be configured to define/determine how to avoid collisions and/or how to perform errorless transmission and/or reception when one or more (e.g., two) grants and/or assignments overlap and/or are multiplexed within the same WD 22. The term PxSCH may refer to and/or include one or more resources 100. Any resource 100 may be indicated using control information (CI) 102. CI 102 may include DCI and/or UCI. Resource 100 may also include one or more slots 104 (e.g., time slots) and/or physical resource blocks 106 and/or transport blocks 110 and/or symbols 112.

Some embodiments provide intra-multiplexing techniques for multiplexing two types of traffic (e.g., XR and URLLC traffic), relaxation of OOO restrictions for such multiplexing techniques, and mechanisms to resolve collisions due to multiplexing/overlapping.

Some other embodiments may include at least one of the following:

### A. XR Allocation (e.g., Initial XR Allocation)

1. In one embodiment, a CI 102a such as DCI allocates a resource (DL or UL shared channel, i.e., PxSCH(s) #1) for the XR traffic which is expected to be transmitted over N slots 104 (e.g., in FIG. 12), where over these N slots 104 (where N≥1), the XR traffic:
   a. Has N transport blocks (TBs) 110 where each TB 110 is transmitted and/or allocated over each slot 104, where these N transmissions are identified with:
      i. Different HARQ IDs:
         1. For example, N transmissions may be allocated with N different HARQ IDs:
         a. In one example, these N HARQ IDs are consecutive HARQ IDs:
         i. N consecutive PUSCH transmissions in the UL or N consecutive PDSCH transmissions in the DL; where the N consecutive PxSCH transmissions represent N different HARQ processes:
         1. Which may be referred to as multi-PUSCH in the UL or multi-PDSCH in the DL or TBoMs;
         2. In another example, N transmissions can be allocated with M HARQ IDs. For example, in each slot 104 there may be two different HARQ transmissions, then M=2×N, where a transmission is less than slot size, e.g., 7 symbols per transmission;
      ii. Same HARQ ID;
   b. Single TB/transmission (spanning over N slots 104), where this transmission is identified with:
      i. A single HARQ ID;
   c. Notation: In option a and b above, the transmission over N slots 104 can be sent as one TB 110 (as one PxSCH) or N TBs 110 (as N PxSCHs). Therefore, a PxSCH(s) (i.e., resource(s) 100) may be associated with an ID for readability #1, i.e., PxSCH(s) #1, so that the PxSCH can be differentiated from URLLC resource PxSCH #2;
   d. The PxSCH(s) can be allocated by single or multiple DCIs (i.e., CIs 102);
2. In 1.a., multi-PxSCH can be allocated using option a, where this DCI (i.e., CI 102) could be:
   a. Dynamic scheduling DCI allocating multi-PUSCH or multi-PDSCH, see 1.-a.-i. where there can be multiple HARQ processes over multi-PxSCHs;
   b. UL CG activation DCI where each period is allocated with multi-PUSCH for transmission of multiple HARQ processes, whereas conventionally, there is only one HARQ process allowed in a CG period; and/or
   c. DL SPS activation DCI where each period is allocated with multi-PDSCH for transmission of multiple HARQ processes, whereas conventionally, there is only one HARQ process allowed in an SPS period;

### B. URLLC Allocation (e.g., Subsequent URLLC Allocation)

3. In one embodiment, a DCI (i.e., CI 102b) allocates a resource (DL or UL shared channel, i.e., PxSCH #2) for the URLLC traffic, shown in FIG. 12, which can overlap with XR allocated resources (discussed in Embodiment 1, i.e., PxSCH(s) #1), which is also shown in FIG. 12. The overlap can happen in following ways:
   a. URLLC resource (PxSCH #2) (i.e., a second resource 100b) can overlap with a subset of XR resources (PxSCH(s) #1) (i.e., a subset of a first resource 100a), as shown in FIG. 12;
   b. XR resource (PxSCH(s) #1) can overlap with a subset of URLLC resources (PxSCH #2);
   c. URLLC resource (PxSCH #2) can overlap with XR resource (PxSCH(s) #1), exactly;
   Note: option 2.-a describes one or more embodiments for resolving collisions (e.g., intra-mux scenario). However, the same concepts can be applied for options 2.-b. and 2.-c;

### C. Collision/Overlapping Resolution

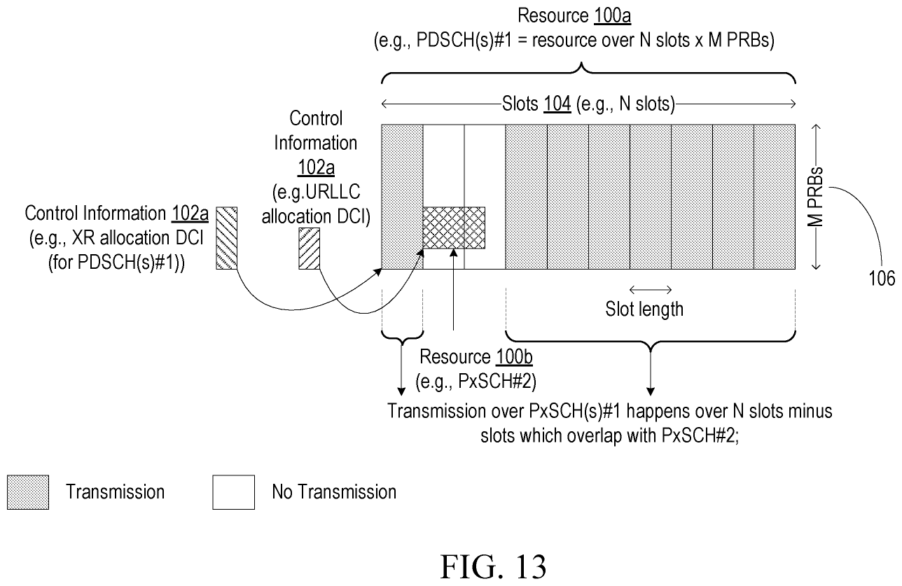

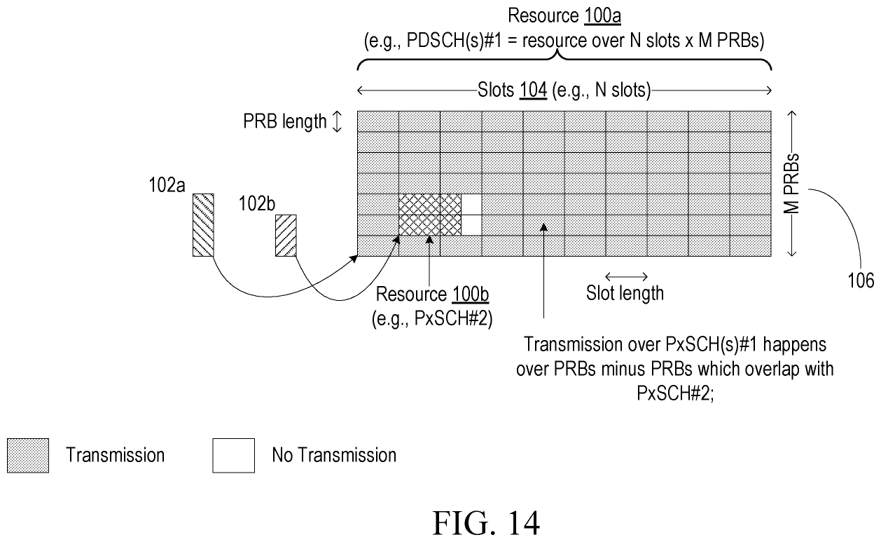

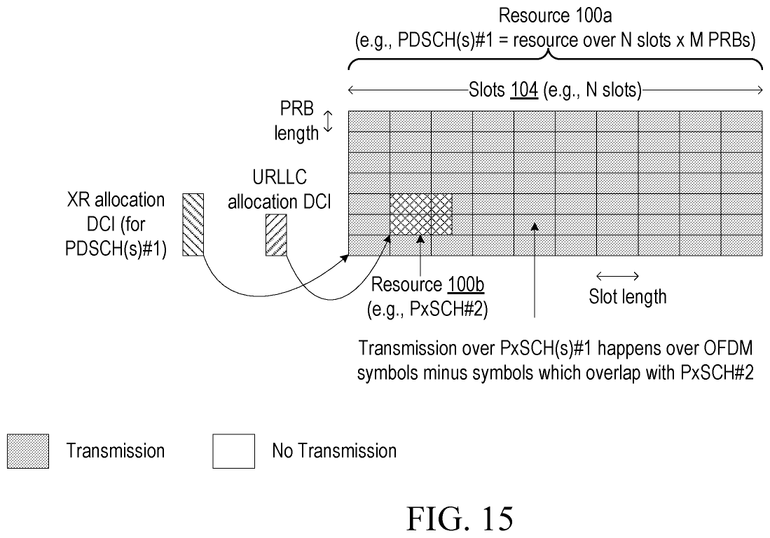

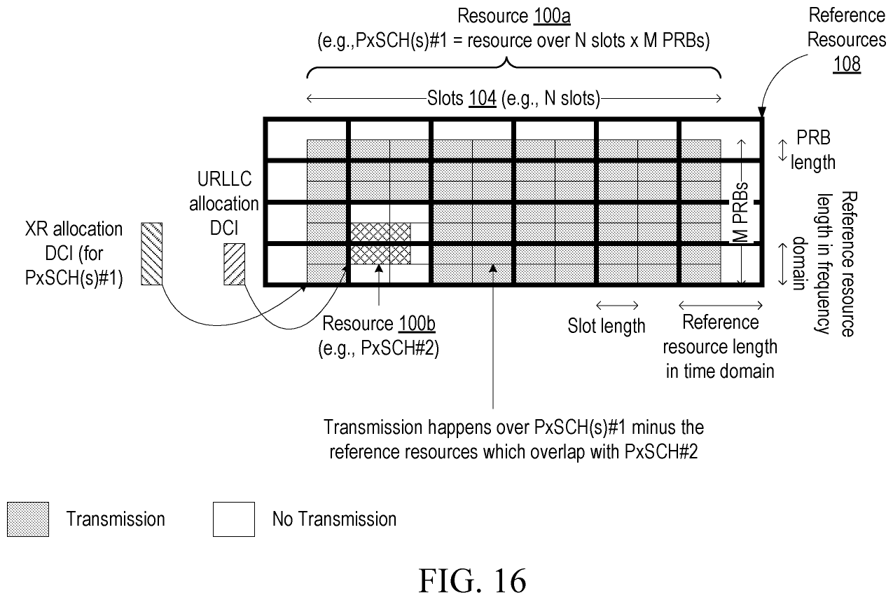

4. In this embodiment, i.e., option 2.-a. scenario, once the WD 22 receives URLLC resource allocation, i.e., PxSCH #2, which overlaps and collides with XR resources, PxSCH(s) #1. The network (i.e., network node 16) determines/decides how to resolve the collision and/or overlap, e.g., so that transmission over PxSCH #2 can happen in an error-free manner. Additionally, the network node 16 may strive to transmit PxSCH(s) #1, also in an error-free manner at least by discarding the overlapping region (which collides with PxSCH #2) of PxSCH #1;
5. In one embodiment, assuming PxSCH(s) #2 allocation is based on option 1., and given that XR has lower priority than URLLC traffic, URLLC traffic (PxSCH #2) may take precedence over the overlapping region. In this embodiment, the WD 22 does not transmit or receive over the subset region of PxSCH(s) #1 over the slots 104 which overlap with PxSCH #2. FIG. 13 shows an example URLLC allocation associated with PxSCH #2 that overlaps with the XR allocation PxSCHs(s) #1. OOO restriction may not be followed. The WD 22 (e.g., and/or network node 16) may be configured to not transmit or receive at least part of PxSCH(s) #1 over the slots 104 which overlap with PxSCH #2;
6. In one embodiment, assuming the PxSCH(s) #2 allocation is based on option 1., and given that XR has lower priority than URLLC traffic, the URLLC traffic (PxSCH #2) takes precedence over the overlapping region. In this embodiment, the WD 22 (e.g., and/or network node 16) may be configured to not transmit or receive at least part of PxSCH(s) #1 over the physical resource blocks (PRBs) over slots which overlap with PxSCH #2. FIG. 14 shows an example URLLC allocation PxSCH #2 overlapping with XR allocation PxSCHs(s) #1. OOO restriction may not be followed. The WD 22 (e.g., and/or network node 16) may be configured to not transmit or receive part of PxSCH(s) #1 over PRBs 106 over the slots 104 which overlaps with PxSCH #2;
7. In one embodiment, assuming PxSCH(s) #2 allocation is based on option 1, and given that XR has a lower priority than URLLC traffic, the URLLC traffic (PxSCH #2) takes precedence over the overlapping region. In this embodiment, the WD 22 does not transmit or receive in PxSCH(s) #1 where the PRBs 106 are over the OFDM symbols 112 in the slots 104 which overlap with PxSCH #2. FIG. 15 shows an example URLLC allocation PxSCH #2 colliding with XR allocation PxSCHs(s) #1. OOO restriction may not be followed. The WD 22 (e.g., and/or network node 16) may be configured to not transmit or receive in PxSCH(s) #1 where the PRBs 106 are over the OFDM symbols 112 in the slots 104 which overlap with PxSCH #2. Note, there are 14 OFDM symbols 112 in a slot 104 in NR;
8. In one embodiment, assuming PxSCH(s) #2 allocation is based on option 1, and given that XR has a lower priority than URLLC traffic, the URLLC traffic (PxSCH #2) takes precedence over the overlapping region. In this embodiment, the WD 22 does not transmit on the subset region of PxSCH(s) #1 over the reference resources which overlap with PxSCH #2. FIG. 16 shows an example URLLC allocation PxSCH #2 colliding with the XR allocation PxSCHs(s) #1. OOO restriction may not be followed. The WD 22 (e.g., and/or network node 16) may be configured to not transmit or receive on the subset region of PxSCH(s) #1 (i.e., resource 100a) over the reference resources 108 which overlap with PxSCH #2 (i.e., resource 100b), i.e., over 2 units of reference resources, where the part of PxSCH(s) #1 is not transmitted. In this example, each unit of reference resource is composed of 2 slots 104 and 2 PRBs 106. The reference resource unit can include Y slots or Y OFDM symbols 112 in the time domain and Z PRBs 108 in the frequency domain. In FIG. 16, Y=2 slots and Z=2 PRBs. These reference resources 108 can be defined in the WD's radio resource control (RRC) information;

### D. On Discarding Type

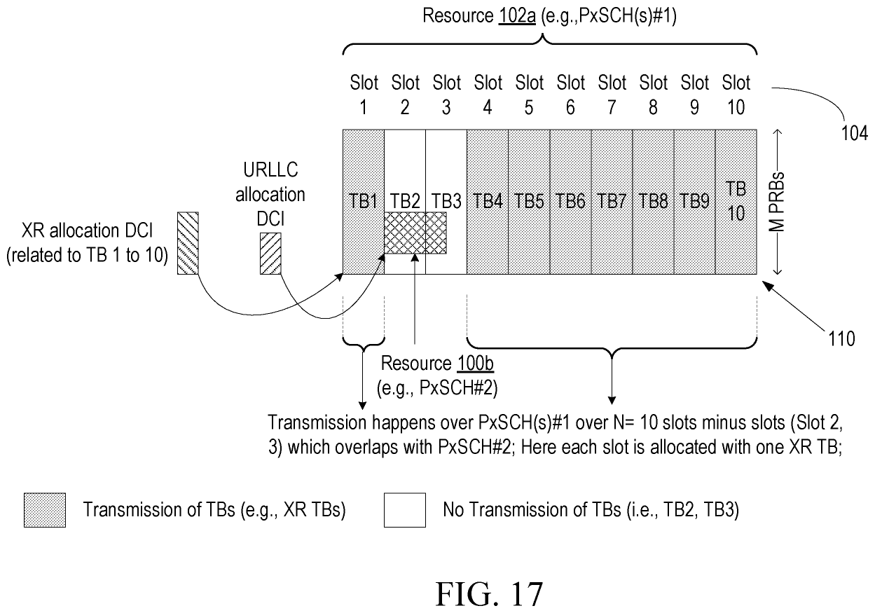

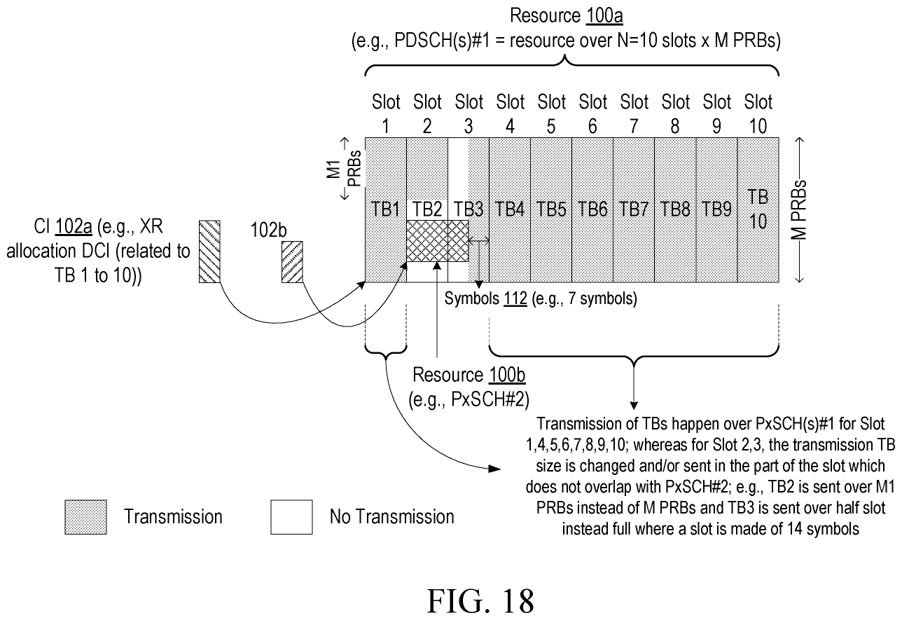

9. In FIGS. 13-16, multiple ways of discarding the XR transmission to accommodate URLLC transmission are shown. Embodiments for discarding the XR transmission include:
   a. The node (WD 22 or network node 16 depending on UL/DL) discards the whole TB 110 (from XR) if it overlaps with URLLC transmission. Consider an example based on FIG. 13, where an XR allocation DCI (i.e., CI 102a) allocates N=10 TBs 110, where each slot 104 is allocated with 1 TB 110. Now, when the URLLC allocation overlaps, the WD 22 and/or network node 16 may be configured to drop those TBs 110 which overlap partially or fully with URLLC allocation. See FIG. 17, where the node (WD 22 or network node 16) drops TB2 and TB3 fully. FIG. 17 shows that the URLLC allocation PxSCH #2 overlaps with XR allocation PxSCHs(s) #1. OOO restrictions may not be followed. The WD 22 does not transmit or receive part of PxSCH(s) #1 over the slots which overlap with PxSCH #2:
      i. TB 1 to 10 related to XR can represent 10 different HARQ process allocations;
   ii. TB 1 to 10 related to XR can represent 10 repetitions of the same HARQ process;
      iii. TB 1 to 10 can represent P HARQ processes, each with Q repetitions, where, e.g., P×Q=10;
      iv. A new HARQ process (in the form of PxSCH #2) may be scheduled where OOO restrictions are not followed;
      v. Note, the above examples i to ii, can be generalized for all embodiments or FIGS. 13-17;
   b. The node (WD 22 or network node 16 depending on UL/DL) discards part of the TB 110 (from XR) if the part of the TB 110 overlaps with URLLC transmission. On the remaining resource, a new TB is built for transmission. Consider FIG. 17, again, where TB2 and TB3 are dropped. Instead of dropping these TBs 110 fully, a new TB can be sent over the resource, e.g., based on rules. This behavior is described in FIG. 18, which shows that the URLLC allocation PxSCH #2 overlaps with XR allocation PxSCHs(s) #1. OOO restrictions may not be followed. If a TB resource partially overlaps with PxSCH #2, then in the remaining resource, a new TB (i.e., another TB 110) may be built and sent and that is related to TB2 and TB3;

### E. On Tb Resizing

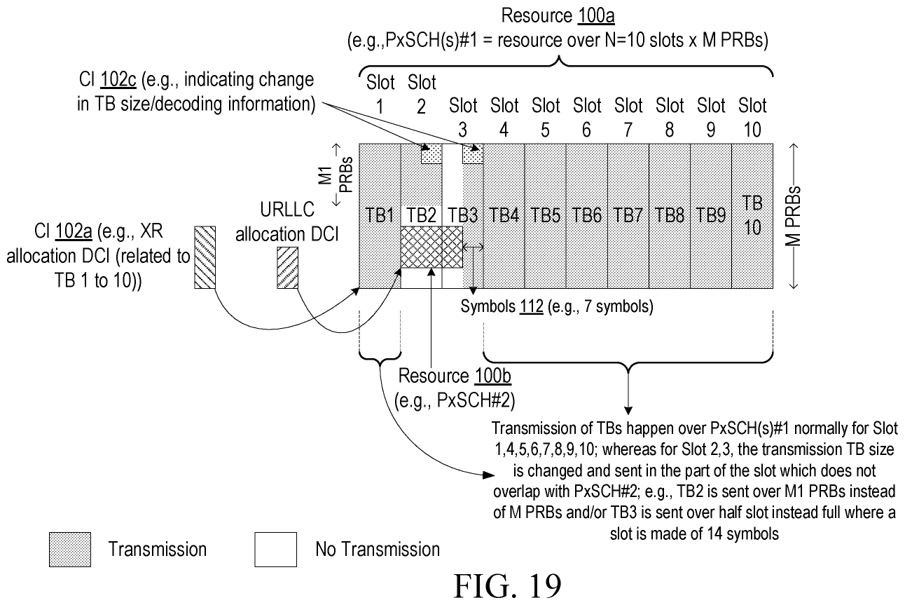

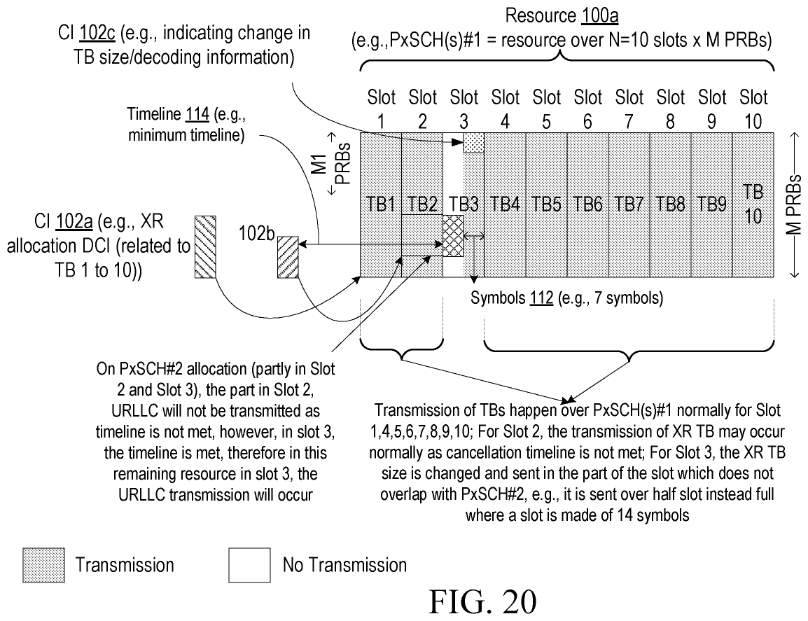

10. In this embodiment, a scenario is described with respect to option 8.-b. Based on one or more embodiments, a TB 110 can be resized as was done in FIG. 20. The receiver (gNB or WD 22) either may have to apply blind decoding as it may be expecting default TB of different size. In order to make life easy for the receiver, the transmitter can send CI (i.e., control information) multiplexed with TB telling how to decode the TB for a receiver. FIG. 19 shows an example an example transmission of configuration information (CI). In addition, CI 102c is transmitted alongside with TBs 110 which are resized so that a receiver (i.e., WD 22 and/or network node 16) need not use blind decoding, as is the case with TB2, TB3 in this example. Some embodiments may include one or both of the following scenarios:
   a. DL scenario: When the network node 16 sends different sized TBs which are not expected by the WD 22 for a default case, the network node 16 may multiplex DCI (CI in DL) indicating changed TB information, e.g., related time domain resource allocation (TDRA), frequency domain resource allocation (FDRA), modulation and coding scheme (MCS), random variable (RV), etc.;
   b. UL scenario: When the WD 22 sends different sized TBs which are not expected by the network node 16, e.g., for a default case, the WD 22 may be configured to multiplex with uplink control information (UCI) (CI in UL) indicating changed TB information, e.g., related TDRA, FDRA, MCS, RV, etc.;

### F. On Incurred Processing Time for Transmission and/or Cancellation and/or Preemption Resolution

11. In above example, when a second DCI (e.g., CI 102b) provides allocation over the overlapping grant, then the overlapping XR part/subset may be excluded in various ways, as shown in FIGS. 13-19. However, in this embodiment, a timeline 114 (e.g., a processing timeline) may be used to determine whether this operation may or may not be executed:
   a. At least one of the following operations may be included in the timeline:
      i. Cancellation of XR allocations (set or subset from PxSCH(s) #1);
      ii. Generation of MAC packet data unit (PDU) for URLLC transmission; and/or
      iii. Transmission of URLLC TBs constructed from URLLC MAC PDU over PxSCH #2;
   b. In one embodiment, if the processing timeline is met (e.g., the WD 22 has at least minimal processing time to execute the action), then the WD 22 can exclude the XR transmission part, and instead transmit the URLLC part;
   c. In one embodiment, if the processing timeline is met (e.g., the WD 22 has at least minimal processing time to execute the action), then the WD 22 cannot exclude the XR transmission part, and instead does not transmit the URLLC part;
   d. In one embodiment, if the WD 22 is unable to receive and/or send a URLLC transmission, the WD 22 can then send a HARQ non-acknowledgment (NACK) or scheduling resource (SR) for non-transmitted URLLC transmissions;
   e. In one embodiment, which is mix of option 10.-a. and 10.-b., the WD 22 is configured to refrain from transmitting the part of the URLLC as the timeline is not met and the remaining part can be sent as timeline is met. FIG. 20 shows another example of a partial transmission where a timeline is used. The transmission over PxSCH #2 resource occurs partially, for the part corresponding to when the timeline is met, i.e., Slot 3. In Slot 2, timeline is not met, therefore WD 22 continues to transmit XR related TB on the overlapping part;

### G. Additional Embodiments

12. In one embodiment, the allocations related to the XR DCI (related to PxSCH(s) #1) (i.e., CI 102a) and the URLLC DCI (related to PxSCH #2) (i.e., CI 102b) may be handled using at least one of:
   Two processing chains, where each chain handles allocation related to each DCI;
   One processing chain; or.
   More than two chains, where multiple chains handle allocation related to single grant;
   Processing chain may refer to at least on of processing of DCI, its scheduling data, preparing a PUSCH, decoding a PDSCH, etc.
13. In one embodiment, the PxSCH #2 allocation may have a higher PHY and/or MAC (Linearization Channel (LCH)/logical channel group (LCG)) priority than PxSCH(s) #1;
   In this embodiments the PxSCH #2 may be preferred over the overlapping region:
14. In one embodiment, the PxSCH #2 allocation can have the same PHY and/or MAC (LCH/LCG) priority as of PxSCH(s) #1:
   PxSCH #2 may be used, e.g., because the network node 16 has scheduled PxSCH #2 over a resource subset meant for PxSCH(s) #1, which means “indirectly” that PxSCH #2 takes precedence over other network node channels where the network node 16 could have scheduled PxSCH #2 over some non-overlapping resource.

According to one aspect, a network node 16 is configured to communicate with a wireless device (WD) 22. The network node 16 includes a radio interface 62 and/or processing circuitry 68 configured to allocate resources for an uplink or downlink shared channel, PxSCH, for extended reality, XR, traffic; allocate resources for the uplink or downlink PxSCH for ultra-reliable low latency communication, URLLC, traffic, at least a portion of the resources allocated for URLLC traffic overlapping at least a portion of the resources allocated for XR traffic; and refrain from transmitting on the downlink, or receiving on the uplink, one of the URLLC traffic or the XR traffic when the resources allocated to URLLC traffic and to XR traffic overlap.

According to this aspect, in some embodiments, when the URLLC traffic has higher priority than XR traffic, then the network node 16, radio interface 62 and/or processing circuitry 68 is further configured to refrain from transmitting the XR traffic when the resources allocated to URLLC traffic and to XR traffic overlap. In some embodiments, when the XR traffic has higher priority than URLLC traffic, then the network node 16, radio interface 62 and/or processing circuitry 68 is further configured to refrain from transmitting the URLLC traffic when the resources allocated to URLLC traffic and to XR traffic overlap. In some embodiments, refraining from transmitting on the downlink or receiving on the uplink occurs during a whole transport block when any part of the XR traffic overlaps URLCC traffic in the transport block. In some embodiments, refraining from transmitting on the downlink or receiving on the uplink occurs only during a portion of a transport block during which the XR traffic overlaps URLCC traffic. In some embodiments, the transport block is resized to fit a size of an overlapping region of the XR traffic and the URLLC traffic.

According to another aspect, a method implemented in a network node 16 includes allocating resources for an uplink or downlink shared channel, PxSCH, for extended reality, XR, traffic; allocating resources for the uplink or downlink PxSCH for ultra-reliable low latency communication, URLLC, traffic, at least a portion of the resources allocated for URLLC traffic overlapping at least a portion of the resources allocated for XR traffic; and refraining from transmitting on the downlink, or receiving on the uplink, one of the URLLC traffic or the XR traffic when the resources allocated to URLLC traffic and to XR traffic overlap.

According to this aspect, in some embodiments, when the URLLC traffic has higher priority than XR traffic, the method further comprising refraining from transmitting the XR traffic when the resources allocated to URLLC traffic and to XR traffic overlap. In some embodiments, when the XR traffic has higher priority than URLLC traffic, the method further comprising refraining from transmitting the URLLC traffic when the resources allocated to URLLC traffic and to XR traffic overlap. In some embodiments, refraining from transmitting on the downlink or receiving on the uplink occurs during a whole transport block when any part of the XR traffic overlaps URLCC traffic in the transport block. In some embodiments, refraining from transmitting on the downlink or receiving on the uplink occurs only during a portion of a transport block during which the XR traffic overlaps URLCC traffic. In some embodiments, the transport block is resized, via the processing circuitry 68, to fit a size of an overlapping region of the XR traffic and the URLLC traffic.

According to yet another aspect, a WD 22 is configured to communicate with a network node 16. The WD 22 includes a radio interface 82 and/or processing circuitry 84 configured to: receive an indication of a first allocation of resources for extended reality, XR, traffic and a second assignment of resources for ultra-reliable low latency communication, URLLC, traffic; and refrain from transmitting on uplink shared channel, or receiving on a downlink shared channel, one of the URLLC traffic and the XR traffic when the resources allocated to the URLLC traffic and to the XR traffic overlap.

According to this aspect, in some embodiments, the WD 22, radio interface 82 and/or processing circuitry 84 is further configured to: receive an indication of which of the URLLC traffic and the XR traffic has higher priority; and refrain from transmitting the one of the URLLC traffic and the XR traffic not having the higher priority when the resources allocated to the URLLC traffic and to the XR traffic overlap. In some embodiments, refraining from transmitting on the uplink or receiving on the downlink of a shared channel occurs during a whole transport block when any part of the XR traffic overlaps URLCC traffic in the transport block. In some embodiments, refraining from transmitting on the uplink or receiving on the downlink of a shared channel occurs only during a portion of a transport block during which the XR traffic overlaps URLCC traffic. In some embodiments, when a timeline of cancelling an XR traffic resource allocation allows the WD 22 to execute the cancelling, then, the WD 22 does one of: excluding transmission of the XR traffic, and instead transmitting the URLLC traffic; or not excluding transmission of the XR traffic, and instead not transmitting the URLLC traffic. In some embodiments, when the WD 22 is unable to receive or transmit URLLC traffic, then the WD 22, radio interface 82 and/or processing circuitry 84 is further configured to send a hybrid automatic repeat request, HARQ, non-acknowledgement, NACK, or a scheduling request, SR, for URLCC traffic that is not transmitted.

According to yet another aspect, a method implemented in a WD 22 includes: receiving an indication of which of the URLLC traffic and the XR traffic has higher priority; and refraining from transmitting the one of the URLLC traffic and the XR traffic not having the higher priority when the resources allocated to the URLLC traffic and to the XR traffic overlap.

According to this aspect, in some embodiments, the method includes receiving, via the radio interface 82, an indication of which of the URLLC traffic and the XR traffic has higher priority; and refraining from transmitting the one of the URLLC traffic and the XR traffic not having the higher priority when the resources allocated to the URLLC traffic and to the XR traffic overlap. In some embodiments, refraining from transmitting on the uplink or receiving on the downlink of a shared channel occurs during a whole transport block when any part of the XR traffic overlaps URLCC traffic in the transport block. In some embodiments, refraining from transmitting on the uplink or receiving on the downlink of a shared channel occurs only during a portion of a transport block during which the XR traffic overlaps URLCC traffic. In some embodiments, when a timeline of cancelling an XR traffic resource allocation allows the WD 22 to execute the cancelling, then, the WD 22 does one of: excluding transmission of the XR traffic, and instead transmitting the URLLC traffic; or not excluding transmission of the XR traffic, and instead not transmitting the URLLC traffic. In some embodiments, when the WD 22 is unable to receive or transmit URLLC traffic, the method further includes sending a hybrid automatic repeat request, HARQ, non-acknowledgement, NACK, or a scheduling request, SR, for URLCC traffic that is not transmitted.

The following is a list of nonlimiting example embodiments:

Embodiment A1. A network node configured to communicate with a wireless device (WD), the network node configured to, and/or comprising a radio interface and/or comprising processing circuitry configured to:
allocate resources for an uplink or downlink shared channel, PxSCH, for extended reality, XR, traffic;
allocate resources for the uplink or downlink PxSCH for ultra-reliable low latency communication, URLLC, traffic, at least a portion of the resources allocated for URLLC traffic overlapping at least a portion of the resources allocated for XR traffic; and
refrain from transmitting on the downlink, or receiving on the uplink, one of the URLLC traffic or the XR traffic when the resources allocated to URLLC traffic and to XR traffic overlap.

Embodiment A2. The network node of Embodiment A1, wherein, when the URLLC traffic has higher priority than XR traffic, then the network node, radio interface and/or processing circuitry is further configured to refrain from transmitting the XR traffic when the resources allocated to URLLC traffic and to XR traffic overlap.

Embodiment A3. The network node of any of Embodiments A1 and A2, wherein, when the XR traffic has higher priority than URLLC traffic, then the network node, radio interface and/or processing circuitry is further configured to refrain from transmitting the URLLC traffic when the resources allocated to URLLC traffic and to XR traffic overlap.

Embodiment A4. The network node of any of Embodiments A1-A3, wherein refraining from transmitting on the downlink or receiving on the uplink occurs during a whole transport block when any part of the XR traffic overlaps URLCC traffic in the transport block.

Embodiment A5. The network node of any of Embodiments A1-A3, wherein refraining from transmitting on the downlink or receiving on the uplink occurs only during a portion of a transport block during which the XR traffic overlaps URLCC traffic.

Embodiment A6. The network node of Embodiment A5, wherein the transport block is resized to fit a size of an overlapping region of the XR traffic and the URLLC traffic.

Embodiment B1. A method implemented in a network node, the method comprising:
allocating resources for an uplink or downlink shared channel, PxSCH, for extended reality, XR, traffic;
allocating resources for the uplink or downlink PxSCH for ultra-reliable low latency communication, URLLC, traffic, at least a portion of the resources allocated for URLLC traffic overlapping at least a portion of the resources allocated for XR traffic; and
refraining from transmitting on the downlink, or receiving on the uplink, one of the URLLC traffic or the XR traffic when the resources allocated to URLLC traffic and to XR traffic overlap.

Embodiment B2. The method of Embodiment B1, wherein, when the URLLC traffic has higher priority than XR traffic, the method further comprising refraining from transmitting the XR traffic when the resources allocated to URLLC traffic and to XR traffic overlap.

Embodiment B3. The method of any of Embodiments B1 and B2, wherein, when the XR traffic has higher priority than URLLC traffic, the method further comprising refraining from transmitting the URLLC traffic when the resources allocated to URLLC traffic and to XR traffic overlap.

Embodiment B4. The method of any of Embodiments B1-B3, wherein refraining from transmitting on the downlink or receiving on the uplink occurs during a whole transport block when any part of the XR traffic overlaps URLCC traffic in the transport block.

Embodiment B5. The method of any of Embodiments B1-B3, wherein refraining from transmitting on the downlink or receiving on the uplink occurs only during a portion of a transport block during which the XR traffic overlaps URLCC traffic.

Embodiment B6. The method of Embodiment B5, wherein the transport block is resized to fit a size of an overlapping region of the XR traffic and the URLLC traffic.

Embodiment C1. A wireless device (WD) configured to communicate with a network node, the WD configured to, and/or comprising a radio interface and/or processing circuitry configured to:
receive an indication of a first allocation of resources for extended reality, XR, traffic and a second assignment of resources for ultra-reliable low latency communication, URLLC, traffic; and
refrain from transmitting on uplink shared channel, or receiving on a downlink shared channel, one of the URLLC traffic and the XR traffic when the resources allocated to the URLLC traffic and to the XR traffic overlap.

Embodiment C2. The WD of Claim C1, wherein the WD, radio interface and/or processing circuitry is further configured to:
receive an indication of which of the URLLC traffic and the XR traffic has higher priority; and
refrain from transmitting the one of the URLLC traffic and the XR traffic not having the higher priority when the resources allocated to the URLLC traffic and to the XR traffic overlap.

Embodiment C3. The WD of any of Embodiments C1 and C2, wherein refraining from transmitting on the uplink or receiving on the downlink of a shared channel occurs during a whole transport block when any part of the XR traffic overlaps URLCC traffic in the transport block.

Embodiment C4. The WD of any of Embodiments C1 and C2, wherein refraining from transmitting on the uplink or receiving on the downlink of a shared channel occurs only during a portion of a transport block during which the XR traffic overlaps URLCC traffic.

Embodiment C5. The WD of any of Embodiments C1-C4, wherein, when a timeline of cancelling an XR traffic resource allocation allows the WD to execute the cancelling, then, the WD does one of:
excluding transmission of the XR traffic, and instead transmitting the URLLC traffic; or
not excluding transmission of the XR traffic, and instead not transmitting the URLLC traffic.

Embodiment C6. The WD of any of Embodiments C1-C5, wherein, when the WD is unable to receive or transmit URLLC traffic, then the WD, radio interface and/or processing circuitry is further configured to send a hybrid automatic repeat request, HARQ, non-acknowledgement, NACK, or a scheduling request, SR, for URLCC traffic that is not transmitted.

Embodiment D1. A method implemented in a wireless device (WD), the method comprising:
receiving an indication of which of the URLLC traffic and the XR traffic has higher priority; and
refraining from transmitting the one of the URLLC traffic and the XR traffic not having the higher priority when the resources allocated to the URLLC traffic and to the XR traffic overlap.

Embodiment D2. The method of Claim D1, further comprising:
receiving an indication of which of the URLLC traffic and the XR traffic has higher priority; and
refraining from transmitting the one of the URLLC traffic and the XR traffic not having the higher priority when the resources allocated to the URLLC traffic and to the XR traffic overlap.

Embodiment D3. The method of any of Embodiments D1 and D2, wherein refraining from transmitting on the uplink or receiving on the downlink of a shared channel occurs during a whole transport block when any part of the XR traffic overlaps URLCC traffic in the transport block.

Embodiment D4. The method of any of Embodiments D1 and D2, wherein refraining from transmitting on the uplink or receiving on the downlink of a shared channel occurs only during a portion of a transport block during which the XR traffic overlaps URLCC traffic.

Embodiment D5. The method of any of Embodiments D1-D4, wherein, when a timeline of cancelling an XR traffic resource allocation allows the WD to execute the cancelling, then, the WD does one of:
excluding transmission of the XR traffic, and instead transmitting the URLLC traffic; or
not excluding transmission of the XR traffic, and instead not transmitting the URLLC traffic.

Embodiment D6. The method of any of Embodiments D1-D5, wherein, when the WD is unable to receive or transmit URLLC traffic, the method further includes sending a hybrid automatic repeat request, HARQ, non-acknowledgement, NACK, or a scheduling request, SR, for URLCC traffic that is not transmitted.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

The invention claimed is:

1.-52. (canceled)

53. A network node configured to communicate with a wireless device, WD, the network node comprising processing circuitry configured to:
allocate at least a first resource for physical uplink or downlink shared channel, PxSCH, for a first type of traffic of the WD, the first resource including multiple slots;
allocate at least a second resource for PxSCH for a second type of traffic of the WD, wherein the second resource overlaps at least in part with the allocated first resource; and
refrain from transmitting and receiving any one of the first type of traffic and the second type of traffic on an overlapping region of the first and the second resource.

54. The network node of claim 53, wherein the processing circuitry is further configured to:
when the second type of traffic has higher priority than the first type of traffic, refrain from transmitting and receiving the first type of traffic on the overlapping region of the first resource.

55. The network node of claim 53, wherein each of the multiple slots includes at least one symbol, and the processing circuitry is configured to: refrain from transmitting and receiving the first type of traffic over any one of:
any slot of the multiple slots that overlaps at least partially with the second resource; and
any symbol of the at least one symbol that overlaps at least partially with the second resource.

56. The network node of claim 53, wherein the first resource includes at least one physical resource block, PRB, and the processing circuitry is configured to: refrain from transmitting and receiving the first type of traffic over any PRB of the at least one PRB that overlaps at least partially with the second resource.

57. The network node of claim 53, wherein the at least first resource includes at least one reference resource, each of which having a first reference resource length in time domain and a second reference resource length in a frequency domain, and the processing circuitry is further configured to:
refrain from transmitting and receiving the first type of traffic over any reference resource of the at least one reference resource that overlaps at least partially with the second resource.

58. The network node of any one of claim 53, wherein the at least first resource includes at least one transport block, and the processing circuitry is configured to: refrain from transmitting and receiving the first type of traffic over any one of:
any transport block of the at least one transport block that overlaps at least partially with the second resource; and
a portion of a transport block of the at least one transport block, overlapping at least partially with the second resource, where another portion of the transport block that does not overlap being indicated to the WD as a resized transport block to be used.

59. A method in a network node configured to communicate with a wireless device, WD, the method comprising:
allocating at least a first resource for a physical uplink or downlink shared channel, PxSCH, for a first type of traffic of the WD, the first resource including multiple slots;
allocating at least a second resource for the PxSCH for a second type of traffic of the WD, wherein the second resource overlaps at least in part with the allocated first resource; and
refraining from transmitting and receiving any one of the first type of traffic and the second type of traffic on an overlapping region of the first and the second resource.

60. The method of claim 59, wherein the refraining comprises, when the second type of traffic has higher priority than the first type of traffic, refraining from transmitting and/or receiving the first type of traffic on the overlapping region of the first resource.

61. The method of claim 59, wherein any one of the first type of traffic and the second type of traffic includes at least one of extended reality, XR, traffic, ultra-reliable low latency communication, URLLC, traffic, enhanced Mobile Broadband, eMBB, traffic, and a traffic associated with a radio access technology.

62. A method in a wireless device, WD, configured to communicate with network node, the method comprising:
receiving a resource allocation indication indicating at least a first resource for physical uplink or downlink physical shared channel, PxSCH, for a first type of traffic of the WD wherein the first resource includes multiple slots;
receiving a resource allocation indication indicating at least a second resource for PxSCH for a second type of traffic of the WD, the second resource overlapping at least in part with the allocated first resource; and
refraining from transmitting and receiving any one of the first type of traffic and the second type of traffic on an overlapping region of the first and the second resource.

63. The method of claim 62, the method comprises: when the second type of traffic has higher priority than the first type of traffic, refraining from transmitting and receiving the first type of traffic on the overlapping region of the first resource.

64. The method of claim 62, wherein each of the multiple slots includes at least one symbol, and the method comprises: refraining from transmitting and receiving the first type of traffic over any one of:
any slot of the multiple slots that overlaps at least partially with the at least second resource; and
any symbol of the at least one symbol that overlaps at least partially with the second resource.

65. The method of claim 62, wherein the first resource includes at least one physical resource block, PRB, and the method comprises: refraining from transmitting and receiving the first type of traffic over any PRB of the at least one PRB that overlaps at least partially with the second resource.

66. The method of claim 62, wherein the at least first resource includes at least one transport block, and the method comprises: refraining from transmitting and receiving the first type of traffic over any one of:
any transport block of the at least one transport block that overlaps at least partially with the second resource; and
a portion of a transport block of the at least one transport block, overlapping at least partially with the second resource, wherein another portion of the transport block that does not overlap being indicated to the WD a resized transport block to be used.

67. The method of claim 62, the method comprising: refraining from transmitting and receiving the first type of traffic until a predetermined processing time associated with any one of the network node and the WD has been met.

68. A wireless device, WD, configured to communicate with network node, the WD comprising:
a memory storing instructions, and
processing circuitry configured to execute the instructions to configure the WD to:
receive a resource allocation indication indicating at least a first resource for physical uplink or downlink physical shared channel, PxSCH, for a first type of traffic of the WD wherein the first resource includes multiple slots;
receive a resource allocation indication indicating at least a second resource for PxSCH for a second type of traffic of the WD, the second resource overlapping at least in part with the allocated first resource; and
refrain from transmitting and receiving any one of the first type of traffic and the second type of traffic on an overlapping region of the first and the second resource.
